(19) United States
(12) Patent Application Publication
(10) Pub. No.: US 2016/0224964 A1
(43) Pub. Date: Aug. 4, 2016

(54) SYSTEMS AND METHODS FOR MANAGING PAYMENT ACCOUNT HOLDERS

(71) Applicant: MasterCard International Incorporated, Purchase, NY (US)

(72) Inventors: Fabiano Vergari, West Bridgford (GB); Andrew A. Robinson, Doncaster (GB); Tirthankar Chakraborty, City Dubai (AE)

(21) Appl. No.: 14/612,838

(22) Filed: Feb. 3, 2015

(51) Int. Cl. G06Q 20/22

(52) U.S. Cl. CPC G06Q 20/227

(57) ABSTRACT

Systems and methods for payment card account portfolio monitoring and optimization that provide issuer financial institutions (FIs) with account holder recommendations about whether or not to take action with respect to one or more of their payment account holders. In some embodiments, the process includes extracting, by a recommendation engine from a payment card transaction database, payment account transaction data of a plurality of payment card accounts, aggregating the payment account transaction data, calculating a payment card account product profitability proxy amount for each payment card account, executing an adaptive optimization process, generating a recommendations file, and then transmitting the recommendations file to an issuer FI computer.

### FIELD OF THE DISCLOSURE

In general, presented are systems and methods for payment card account portfolio monitoring and optimization. In particular, systems and methods are disclosed for providing issuer financial institutions (FIs) with payment account holder recommendations concerning whether to take any action(s) with respect to one or more of their payment account holders. In some embodiments, one or more recommended actions may be provided to an issuer FI that are customized to each cardholder associated with that issuer FI.

### BACKGROUND

Issuing financial institutions (FIs), such as banks, conventionally examine their own portfolio of payment card accounts in an attempt to discern cardholders' spending behaviors. For example, an issuer FI may analyze cardholder data to try to predict future behavior and to possibly act and/or react accordingly. In some cases, an issuer FI will generate a propensity score that can be used to predict a cardholder's likelihood of future use of a credit facility. For example, a high propensity score may be given to a person who uses his or her credit card for purchases and pays only the minimum amount each month. Such cardholders are very profitable as compared to other cardholders who pay off their credit card balance in full every month.

Issuer FIs may also examine their payment card account portfolios to determine when and how to conduct a marketing campaign to target one or more groups of cardholders in an attempt to increase revenues. In some cases, an issuer FI may compare the performance of its consumer payment card portfolio to the performance of the consumer payment card portfolios of other issuer FIs in an attempt to identify any trends and/or identify any opportunities for growth. The issuer FI may be able to identify one or more opportunities and then a marketing analyst may be employed to make recommendations for conducting a marketing campaign. For example, a bank that issues different types of credit cards may infer that some cardholders may be using their personal credit card accounts as business accounts because a large amount of office supplies have been purchased over a particular period of time. A marketing analyst may use this insight to recommend sending out a mailing to those payment account consumers (or that group of cardholders) with offers to upgrade their personal credit card accounts to business payment card accounts. The business payment card accounts could be structured in a manner to provide these consumers with additional benefits when used to purchase office supplies, for example, with the expectation that these consumers would use business payment cards to increase their purchases which would then generate more revenues for the issuer bank. In another example, an issuer bank may evaluate its existing business payment card account portfolio and recognize that many business card account holders rarely use their cards. The marketing analyst in this case may recommend that the issuer bank create a business payment card account rewards program that includes a cash back option when the business payment cards are used for business meals and/or business entertainment in order to further incentivize additional uses of the business payment card accounts.

In many cases, issuer FIs evaluate the spending behaviors of cardholders in their own cardholder portfolios using data available over a “closed network”. Such closed networks usually contain a limited amount of data, and thus it may not be possible to perform an optimum analysis of potential revenue growth opportunities. Moreover, smaller size issuer FIs (such as some local banks and/or regional banks) may not have the resources to perform data analysis on their own payment card account holders. Such issuer FIs therefore may miss opportunities for contacting one or more of their cardholders in order to maintain a good credit card relationship, for example, or to prevent attrition of desirable payment card accounts by proactively offering incentives to some cardholders, such as additional benefits and/or credit upgrades.

### BRIEF DESCRIPTION OF THE DRAWINGS

FIG. 1 is block diagram of a payment and recommendation system according to some embodiments of the disclosure;

FIG. 2 is a block diagram of an example of a recommendation engine for providing cardholder recommendations functionality according to some embodiments of the disclosure;

FIG. 3 is a schematic block diagram of an embodiment of the recommendation database shown in FIGS. 1 and 2;

FIG. 4 illustrates an example of a recommendation data file (or objectives file) in a table format according to some embodiments of the disclosure;

FIG. 5A is a flowchart illustrating a data management and account optimization process according to some embodiments of the disclosure;

FIG. 5B is a flowchart illustrating an embodiment of the account optimization process of FIG. 5A; and

FIG. 6 is a table illustrating a guide for determining a key business objective for a cardholder based on various factors according to some embodiments of the disclosure.

### DETAILED DESCRIPTION

Issuer financial institutions (FIs) such as banks are interested in obtaining information and/or analysis concerning their payment account holders in order to take one or more strategic actions when required to meet one or more business objectives. For example, it would be of interest for an issuer FI to know when a particular payment account holder and/or customer and/or cardholder has changed his or her spending habits to such an extent that it is likely that the cardholder will decrease usage further and/or stop using his or her payment card account. It may be an advisable strategy in such cases for the issuer FI to contact that cardholder and offer him or her one or more incentives to increase usage of the payment card account, such as an increase in rewards points or cash back for certain purchases. In some cases, it may be strategically advisable to take other action(s) in an attempt to improve the relationship between the cardholder and the issuer FI so as to retain that cardholder as a customer. It may also be advisable for a representative of an issuer FI to contact a cardholder (for example, via text message or e-mail or telephone call) if an unusual or unexpected event or events occur, such as an unexpected purchase of an expensive item in a foreign country, or an indication of an atypical purchase pattern for that cardholder, to prevent fraud.

As used herein, the term “issuer” or “attribute provider” can include, for example, a financial institution (i.e., a bank) issuing a payment card, a merchant issuing a merchant specific payment card, a stand-in processor configured to act on-behalf of the card-issuer, or any other suitable institution and/or device configured to issue a payment card.

Systems and methods for payment card account portfolio monitoring and optimization are disclosed. In particular, systems and methods described herein provide an issuer FI with one or more recommended strategic actions concerning one or more of their payment card account customers. In some embodiments, an issuer FI enrolls or registers for the recommendation service with, for example, a recommendation engine associated with a payment card network. The recommendations engine then monitors the usage of one or more consumer payment card accounts issued by that issuer FI. In some implementations, the recommendation engine determines, based on predefined rules and/or models, what strategic action or actions could be taken by an issuer FI at a particular point in time in order to improve customer payment card account engagement and usage. The recommendations engine may examine each payment card account on its own merit, independently of all of the other payment card accounts in a portfolio of an issuer FI. In some implementations, the recommendation engine provides an output recommendation(s) file to an issuer FI that may contain one or more payment card account numbers, tags defining the type of attention required, and proposed or suggested treatment for the one or more payment card account holders (cardholders). In an embodiment, one entry for each cardholder associated with an issuer FI is included along with a strategic recommendation (which may include, but are not limited to, recommendations such as providing a reward, cross-selling, retaining, upgrading, and/or not contacting a cardholder). The recommendation file may be a computer readable file and thus may be provided by the recommendations engine to an issuer FI computer or other issuer device. Such a recommendation file may be provided on demand, and/or on a periodic basis, and/or when one or more unusual or unexpected or potentially fraudulent events occur (such as a purchase in a foreign country of an expensive item, or a suspicious pattern of purchases which may be fraudulent).

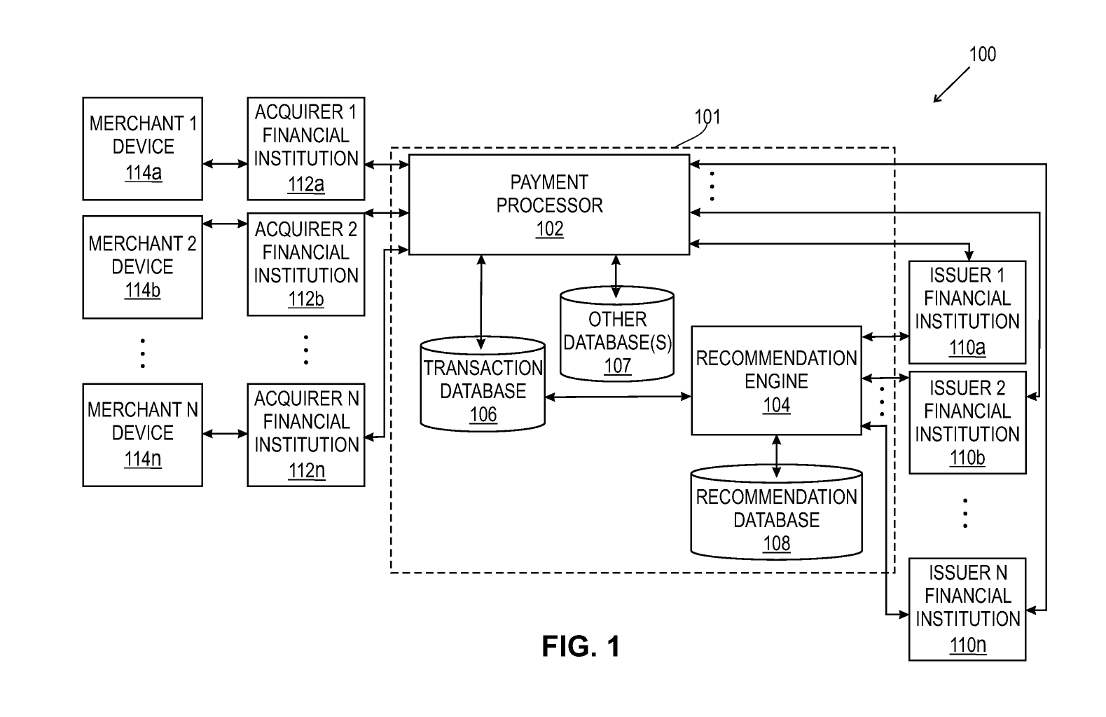

FIG. 1 is block diagram of a purchase transaction and strategic action recommendation system 100 according to some embodiments. The various blocks and/or components shown in FIG. 1 may represent electronic devices such as computers and/or computer systems, and a number of entities and/or apparatus that interact to provide, for example, purchase transaction processing, payment card account information, updates, support messages, alerts, recommendation files, and/or other messages or transaction data. In particular, the purchase transaction and strategic action recommendation system 100 includes a payment network 101 that includes a payment processor 102 operably connected to a transaction database 106 and other database(s) 107, and a recommendation engine 104 that is operably connected to the transaction database 106 and to a recommendation database 108. The payment network 101 may include one or more processors, controllers, computers and/or computer systems (not specifically shown) and/or other electronic components such as input devices, output devices and/or communication devices (not shown). As illustrated, the payment network 101 is in communication with a plurality of issuer financial institutions (FIs) computers 110a, 110b to 110n and with a plurality of acquirer financial institutions (FIs) computers 112a, 112b to 112n. The acquirer FI computers are also in communication with one or more merchant devices 114a, 114b to 114n. Any number of issuer FIs, acquirer FIs and/or merchant devices may be included in the payment system 100.

As used herein, devices and/or components, including those associated with the payment network 101 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

It should be understood that the term “payment network” or “payment card network” as used herein refers to a payment network or payment system operated by a payment processing entity, or other networks which process payment transactions on behalf of a number of merchants, issuers and payment account holders (such as credit card and/or debit card account cardholders). An example of a suitable payment system is the well-known Banknet™ system operated by MasterCard International Incorporated, the assignee hereof. In addition, the terms “payment card network data” or “payment card transaction data” or “network transaction data” or “payment account transaction data” refer to transaction data associated with purchase transactions and/or payment transactions that have been processed over a payment network. For example, network transaction data may include a number of data records associated with individual payment transactions (or purchase transactions) of consumers that have been processed over a payment card network. In some embodiments, network transaction data may include information that identifies a payment device and/or payment account, transaction date and time, transaction amount, information identifying a merchant and/or a merchant category, and/or additional transaction details.

Referring again to FIG. 1, the purchase transaction and strategic action recommendation system 100 is operable to process purchase transactions that may be initiated by cardholders (consumers or customers) who hold or own payment card accounts issued by issuer FIs 110a to 110n. The cardholders present their payment cards at any of the plurality of merchant devices 114a to 114n (which may be, for example, merchant point-of-sale (POS) terminals having payment card readers (such as cash registers with associated magnetic stripe readers), or merchant mobile devices, and/or merchant websites). Thus, as used herein, the term “transaction” or “purchase transaction” can be associated with, for example, a merchant, a merchant device (such as a merchant terminal, an automated teller machine (ATM), and/or a merchant website), or any other suitable institution or device configured to initiate a financial transaction per the request of a payment card account holder.

By way of example, and without limiting the generality of the foregoing, a payment card can be a credit card, debit card, charge card, stored-value card, or prepaid card or nearly any other type of financial transaction card. When a consumer presents his or her payment card to, for example, a merchant POS terminal, an associated reader device (not shown) operates to obtain customer account data from the payment card and then transmits that customer payment card account data and the transaction data with an authorization request for the purchase to an acquirer FI computer. For example, a purchase transaction involving merchant device 114a may be transmitted to the acquirer1 FI computer 112a, which may be operated by an acquirer bank that is associated with a plurality of merchants, including the merchant associated with merchant device 114a. It should be understood that each acquirer FI computer 112a to 112n may operate in a conventional manner to receive authorization requests for purchase transactions from merchants, and may transmit such authorization requests to the payment processor 102 for routing to the appropriate issuer FI. Thus, an authorization request and transaction data is transmitted from merchant1 device 114a to the acquirer1 FI server computer 112a and then forwarded to the payment processor 102. The payment network 102 receives the transaction information, which may include the primary account number (PAN) of the customer's payment card account, and performs a lookup function, for example, utilizing the database 107. The PAN includes a bank identification number (BIN) that identifies the financial institution that issued the payment card account (the issuer FI). The BIN conventionally includes a two-part code that is assigned to banks and savings associations, wherein the first part of the BIN relates to a location and the second part identifies the bank itself. Thus, the payment network 102 may utilize the BIN to identify the appropriate issuer FI (the bank that issued the customer's payment card account) as being the bank associated with the issuer FI computer 110a, and then the payment network routes the purchase transaction authorization request thereto. If all is in order (for example, the customer has adequate credit to cover the cost of the purchase amount and that payment card has not been reported as lost or stolen), the payment card issuer FI server computer 110a generates and transmits an authorization response message that is routed back to the merchant device 114a via the payment network 102 and the acquirer1 FI computer 112a.

In some cases, however, additional security measures may be associated with verifying the cardholder before an authorization response message is generated. Such security measures may entail, for example, obtaining the account owner's signature for verification, or obtaining a personal identification number (PIN), or enforcing a customer verification method (CVM) that may require input of biometric data (such as an iris scan, fingerprint or voice print) by the cardholder. Thus, after all such security measure requirements are met and purchase transaction authorization is received, the merchant permits the customer to leave the retail store with his or her purchase, or electronically checkout if the purchase transaction occurs online over the Internet. In a typical credit card arrangement, the customer (the payment account owner or cardholder) is then required to repay the issuer bank for the purchase transactions, generally on a monthly basis.

As payment card account transaction processing occurs, the payment processor 102 stores purchase transaction information and/or transaction data associated with each customer payment card account in the transaction database 106. For example, transaction information for a particular purchase transaction may include, for example, a payment card account identifier (which may be a primary account number (PAN)), a merchant identifier, a date, a time of day, a payment amount, a payment description, or any other type of transaction information. Thus the data in the transaction database 106 may include, for example, a listing of each payment card transaction processed by the payment network that includes the type of goods and/or services sold, a total number of goods and/or services sold in a transaction, and a total sales amount for each transaction (e.g., gross dollar amount). The information in the transaction database 106 may be associated with a “credit card processing network” such as the MasterCard® network operated by the assignee of the present application, which allows the payment account owners to use their payment cards issued by a variety of issuer FIs to purchase items at a variety of participating merchants.

In accordance with the present disclosure, the recommendation engine 104 associated with the payment network 101 is operable to provide output files that contain recommendation data concerning strategic recommended actions for one or more cardholders associated with one or more of the issuer FIs 110a to 110n. In an implementation, the recommendation engine 104 analyzes the transaction data in the transaction database 106 that was stored during payment transactions and that is associated with cardholders of an issuer FI enrolled with and/or subscribed to the recommendation service, as described herein. A particular issuer FI may utilize the recommended actions data to take one or more strategic actions concerning one or more customers or cardholders. The processes disclosed herein resulting in one or more recommendations for one or more cardholders may be used by issuer FIs to better monitor and/or to optimize their payment account portfolio.

In some embodiments, a computer readable file containing a list of recommended strategic actions concerning one or more customer payment accounts may be provided to an issuer FI computer on demand, and/or on a periodic basis, and/or when one or more atypical and/or unusual events occur (such as a potentially fraudulent purchase transaction). In particular, the recommendation engine 104 may operate in any of the ways described herein to output a recommendation file (or files) containing a list of cardholders with associated recommended actions, and to transmit the recommendation file(s) to a particular issuer FI, such as the issuer FI 110a. The recommendations in the recommendation file(s) may then be considered by the issuer FI 110a for taking one or more strategic actions regarding one or more of their cardholder accounts. In some embodiments, an issuer FI may filter the recommendation data concerning one or more cardholder payment accounts appearing in the recommendation file received from the recommendation engine 104. For example, a particular issuer FI may have a rule that a particular customer or cardholder cannot be contacted more than once per quarter, and thus even if a recommended strategic action involves offering a reward to that cardholder the issuer FI will not do so if the cardholder was already contacted that quarter. In another example, the issuer FI may enforce a rule that all strategic actions for customers approached over the past three (3) months should be suppressed.

In some implementations, the recommendation engine 104 may be, for example, associated with a Personal Computer (PC), laptop computer, an enterprise server, a server farm, and/or a database or similar storage devices. As shown in the embodiment of FIG. 1, the recommendation engine 104 is operably connected to the transaction database 106 and to a recommendation database 108, but additional and/or other database(s) may also be utilized. In some embodiments, the recommendation database 108 stores instructions and/or other computer-readable data for causing the recommendation engine 104 to operate in accordance with methods and/or processes disclosed herein.

According to some embodiments, an “automated” recommendation engine 104 may facilitate communications with one or more of the Issuer FIs 110a, 110b to 110n. As used herein, the term “automated” may refer to, for example, actions that can be performed with little (or no) intervention by a human. For example, after a particular issuer FI contracts to obtain recommendation data with the operator of the payment network 102, the recommendation engine 104 may be programmed to automatically identify the cardholder accounts of that issuer FI, automatically analyze those cardholder accounts, and automatically output a file containing a list of one or more recommendations associated with each cardholder account for transmission to the Issuer FI. Such a recommendations file may be generated and automatically transmitted to an issuer FI on a predetermined periodic basis, and/or when potentially fraudulent activities occur. A predetermined periodic time frame for providing reports may be agreed upon between an issuer FI and the payment system operator, and the agreement could call for, for example, to provide a report or file containing recommendations for each cardholder on a daily basis, on a weekly basis, a monthly basis, a quarterly basis, every six months, or yearly, as well as upon request of an issuer FI. Appropriate fees for such a recommendations service may also be agreed upon between each issuer FI and the payment network operator, and may depend upon various considerations and/or variables, such as the size of a particular issuer FI's payment card account portfolio, the frequency with which recommendation reports or files are provided, and/or the detail(s) provided in each recommendation report.

In some embodiments, the recommendation engine 104 retrieves transaction information from the transaction database 106, wherein the transaction information is associated with, for example, credit card accounts and/or debit card accounts of customers of a plurality of issuer FIs. Accordingly, the recommendation engine may utilize the bank identification number (BIN) to identify individual issuer FIs during processing. The transaction database 106 may be locally stored, or it may reside at a location remote from the recommendation engine 104. As will be described below, the transaction database 106 may be used by the recommendation engine 104 to automatically or periodically (or on demand) generate recommendations for the cardholder accounts of one or more issuer FIs 110a to 110n. In some embodiments, the recommendation engine 104 communicates the recommendation information to an external device (not shown), such as by transmitting an electronic file to an email server, a workflow management system, and the like. In some embodiments, the recommendation engine 104 may utilize rules and/or instructions and/or data stored in a recommendation database 108 to process data from the transaction database 106, and may also store recommendation information and/or recommended action data in the recommendation database 108. In some embodiments, some rules and/or instructions in the recommendation database 108 may be customized for one or more of the issuer FIs, and in some cases the rules and/or instructions may be provided by one or more issuer FIs for application by the recommendation engine 104 when processing the transaction data associated with their cardholders.

For example, a recommendation output file may include a list of every cardholder and/or payment card account by payment card identification number, and may include information or data related to a segment in which the cardholder account has been classified, a sub-segment of the cardholder account (if appropriate), a transaction value, one or more trigger events, and an objective or recommended action point that the issuer bank may wish to take with regard to that customer or cardholder. Each payment card account may have one or more objectives or action items associated with it, and some payment card accounts may have a recommendation to do nothing for that particular time period because the customer is performing up to an expected level (which may be an average level) for that particular type of payment account and/or segment or sub-segment or because it is deemed uneconomical to try and revive its sub-optimal performance. After considering the recommended objectives, the issuer FI or bank may then choose to implement one or more of those action items associated with one or more of their customers. In some situations, the bank may also provide, via the processor 302, feedback to the recommendation engine 104 along with a request for further processing based on cardholder actions that the issuer bank took. However, it should be understood that the recommendation service, in general, does not require regular feedback from any of the issuer FI's enrolled with the recommendation service.

Referring again to FIG. 1, although a single recommendation engine 104 is shown, any number of such devices may be included. Moreover, various devices described herein might be combined according to some embodiments. For example, in some implementations, the payment processor 102, the recommendation engine 104, the transaction database 106, and/or the recommendation database 108 may be co-located and/or may comprise a single apparatus.

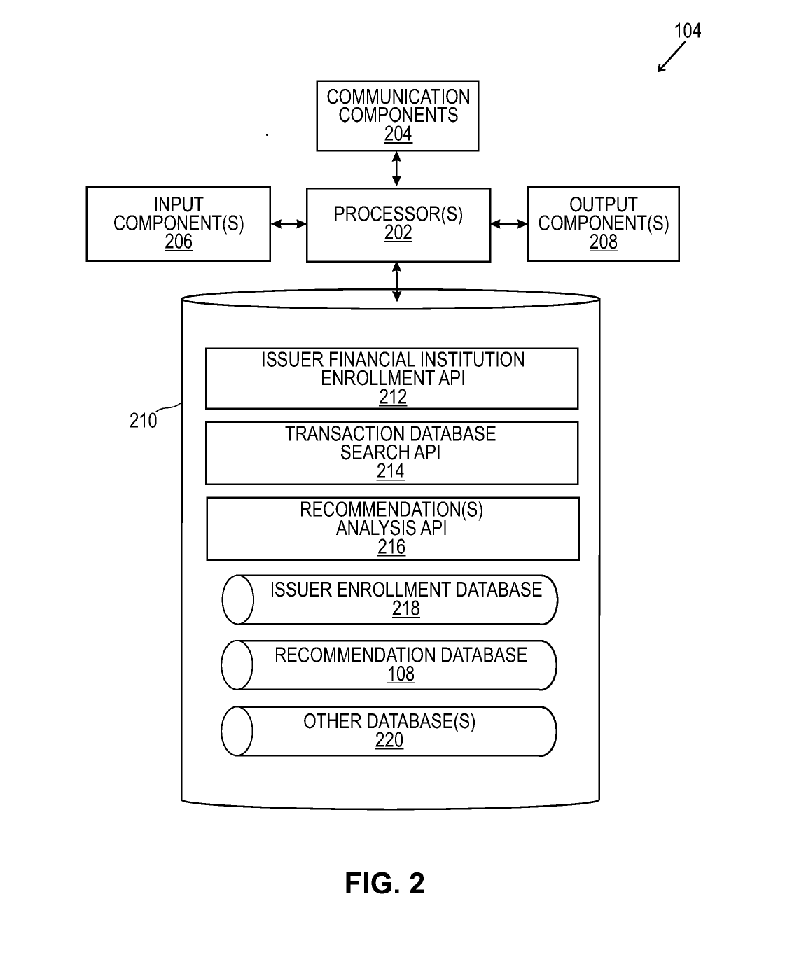

FIG. 2 is a block diagram of a recommendation engine 104, which may be, for example, a server computer configured to provide cardholder recommendations functionality according to embodiments of the disclosure. Such a recommendation engine may be owned and/or operated by a payment card system operator such as MasterCard International Incorporated, the assignee hereof. As shown in FIG. 2, a computer processor 202 is operatively coupled to communication component(s) 204, input component(s) 206, output component(s) 208, and a storage device 210.

The computer processor 202 may be constituted by one or more conventional processors. Processor 202 operates to execute processor-executable steps, contained in program instructions described herein, so as to control the recommendation engine 104 to provide desired cardholder recommendation functionality.

Communication component(s) 204 may be used to facilitate communication with, for example, other devices (such as issuer FIs and/or one or more databases). Communication component(s) 204 may, for example, have capabilities for sending and receiving messages over WiFi networks, via the Internet, and/or engaging in data communication over conventional computer-to-computer data networks.

Input component(s) 206 may comprise one or more of any type of peripheral device typically used to input data into a computer. For example, the input device 206 may include a keyboard and/or a mouse or may be a touchscreen. Output component(s) 208 may comprise, for example, a flat-screen display, a touchscreen display and/or an audio speaker or some other type of output device.

Storage device 210 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory. Thus, the storage device 210 is a non-transitory computer readable medium and/or any form of computer readable media capable of storing computer instructions and/or application programs and/or data. It should be understood that non-transitory computer-readable media comprise all computer-readable media, with the sole exception being a transitory, propagating signal.

Storage device 210 stores one or more programs or applications for controlling the processor 202. The programs comprise program instructions that contain processor-executable process steps of the recommendation engine 104, including, in some cases, process steps that constitute processes provided in accordance with principles of the present invention, as described herein.

The programs stored by the storage device 210 may include an issuer FI enrollment application programming interface (API) 212 that manages a process by which issuer FIs contact the recommendation engine 104 and enroll or register for the recommendation service. In some implementations, the issuer FI enrollment API 212 also functions to obtain data from each enrolled issuer FI that identifies which cardholder accounts are of interest. The storage device 210 may also include a transaction database search API 214, which functions to search the data stored in the transaction database 106 (FIG. 1) over a predetermined period of time and obtain transaction data for the cardholder accounts of interest. In addition, the storage device 210 may include a recommendations analysis API 216 that is operable to process the transaction data for cardholder accounts of interest in accordance with various rules and/or models and generate one or more output files for transmission to one or more issuer FIs.

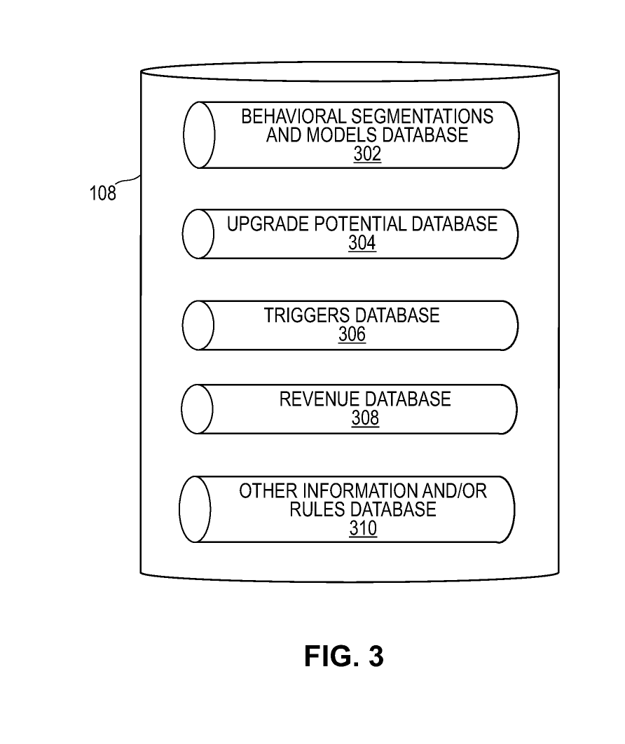

The storage device 210 may also store one or more databases, such an issuer FI enrollment database 218, a recommendation database 108, and other database(s) 220). The issuer FI enrollment database 218 may include issuer FI data associated with issuer FI registration, including identification of cardholder payment accounts of interest. The recommendation database may include various rules and/or models for use to generate recommended actions, which will be explained with regard to FIG. 3. Lastly, other database(s) 220 may also be included, for storing and/or obtaining various types of information and/or data.

The application programs of the recommendation engine 104 may be combined in some embodiments, as convenient, into one, two or more application programs. Moreover, the storage device 210 may store other programs, such as one or more operating systems, device drivers, database management software, web hosting software, and the like.

FIG. 3 is a schematic block diagram of the recommendation database 108 of FIGS. 1 and 2 according to some embodiments. It should be understood that the recommendation database 108, and any other storage device disclosed herein, may comprise any appropriate information storage device, including combinations of magnetic storage devices (e.g., a hard disk drive), optical storage devices, and/or semiconductor memory devices. Such storage devices may therefore be any type of non-transitory computer readable medium and/or any form of computer readable media capable of storing computer instructions and/or application programs and/or data. It should be understood that non-transitory computer-readable media comprise all computer-readable media, with the sole exception being a transitory, propagating signal.

Referring again to FIG. 3, the recommendation database 108 includes a behavioral segmentations and model database 302, an upgrade potential database 304, a triggers database 306, a revenues database 308, and may include one or more other information and/or rules database(s) 310. Such databases may include instructions and/or data for use by the recommendations engine 104 to operate according to the processes described herein. In particular, the behavioral segmentations and model database 302 may contain data and/or instructions for causing the recommendations engine to classify behavior and monitor the changes and/or trigger actions based upon segment movements of a customer's payment card account. Such segment movements may occur over a predefined recent time period, for example, a three month period that includes the present date (or date of analysis) as the end date. The upgrade potential database 304 may contain data and/or instructions for causing the recommendations engine 104 to determine whether a payment card account may be suitable for an upgrade action based upon the cardholders' purchasing activity over a predefined recent time period. The triggers database 306 may contain data and/or instructions for causing the recommendations engine 104 to recommend one or more specific priority contact actions for a customer or cardholder to the issuer FI. For example, the triggers database may include a list of predefined customer behaviors (or triggers) and associated contact actions, which contact action or actions should be followed by an issuer FI when a customer or cardholder utilizes his or her payment card account in a particular manner or manners.

The revenues database 308 of FIG. 3 may include instructions and/or data focusing on spend-related revenue for use by the recommendation engine 104, for example, to prioritize best payment card incentives or offers actions for any particular customer or cardholder, and/or for use by the recommendation engine to identify payment card account portfolio areas (which include two or more cardholders) where revenue improvement may be possible and/or desired. The other information and/or rules database 310 may include, for example, an operating system, a database management system, device drivers, and/or any other data and/or instructions required by the recommendations engine to function in accordance with the processes disclosed herein.

In some embodiments, an issuer FI and the entity that operates and maintains the recommendation engine 104 (i.e., a payment processing company) agrees on a business objective process that includes a description of the steps involved and/or the rules and/or instructions utilized by the recommendation engine to determine one or more recommended actions or objectives for the cardholders of the issuer FI. Consequently, the processes disclosed herein are understood by the issuer bank, and do not constitute a ‘black box’ type of process. Accordingly, the business objective flow or process describes the sequential steps that are required to first, evaluate each customer's payment account performance, and to second, determine the appropriate next action for the issuer FI to take with regard to that customer. In some embodiments, segmentation values and propensity scores prepared by the payment network operator and/or the recommendation engine based only on the transaction data will be available for use. In addition, each process objective or action item of the process may leverage expert rules and/or analytical tools developed by the payment network operator as appropriate. Moreover, in some implementations, the overall process is adaptive, and cardholder or payment account action recommendations may be allocated or presented sequentially, one payment card account at a time for the issuer FI.

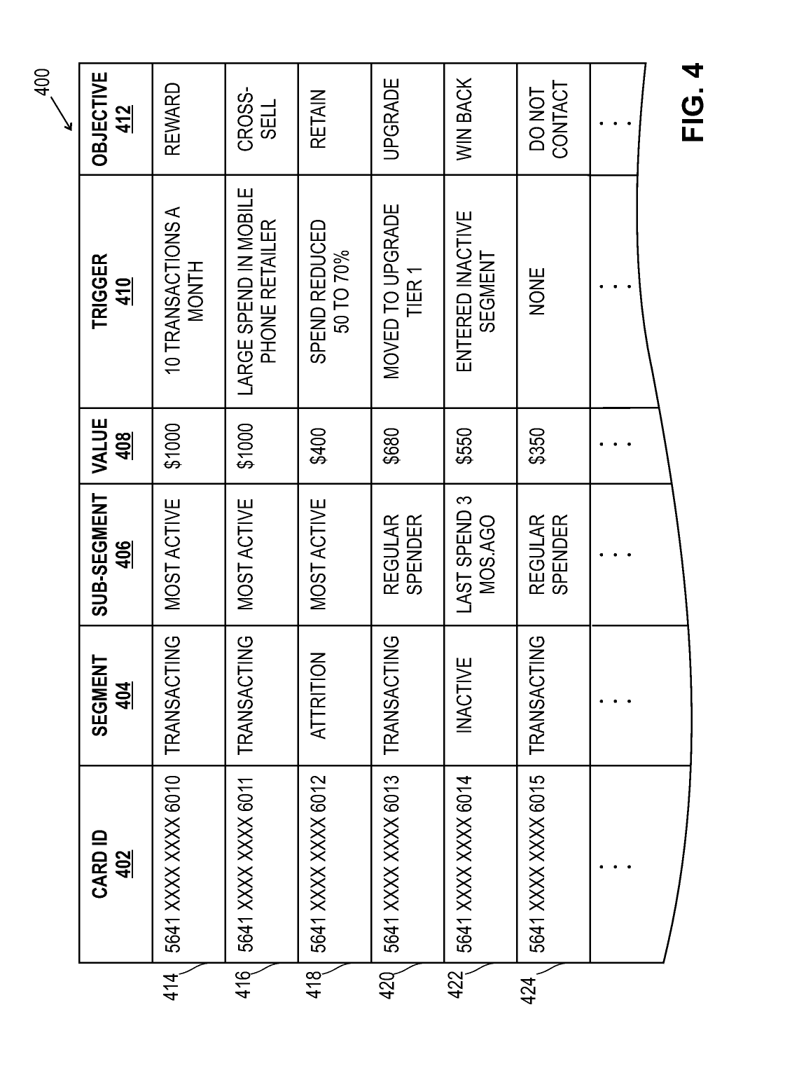

FIG. 4 illustrates an example of a recommendation data file 400 (or objectives file) in a table format that may be provided to an issuer FI according to some embodiments. In some implementations, the recommendation data file 400 includes one entry for each cardholder or customer in a payment card account portfolio of a particular issuer FI, and the cardholder accounts may be presented in a sequential order (as shown). In the example shown in FIG. 4, the table 400 includes a Card identification column 402, a Segment column 404, a Sub-Segment column 406, a Value column 408, a Trigger column 410 and an Objective column 412, but more or less columns may be included. Cardholders or payment card accounts may appear row-by-row in order of card identification number. For example, a first cardholder having a payment card account number ending in “6010” appears in row 414, a second cardholder having a payment card account number ending in “6011” appears in row 416, and so forth through the rows of the table 400. A predetermined time period of interest may correspond to a daily time frame, a weekly time frame, a monthly time frame, a quarterly time frame, and the like, which may be based on the preferences and/or desires of the issuer FI or issuer bank. Referring to row 414, the cardholder having a card identifier ending in 6010 is in the “transacting” segment (meaning that he or she actively uses that card account to make purchases), is in the “most-active” sub-segment (which may have different meanings for different issuer FIs, but which in general means that the cardholder utilizes his or her payment card in-line for what would be expected for a “front of wallet” payment card), and has a “value” of one-thousand ($1000) U.S. dollars. In addition, the cardholder has triggered or activated a “trigger” event, which in this case is “ten transactions per month” (which may have been for a predetermined number of months). In some embodiments, such a trigger event (in combination with the segment, sub-segment and value data) causes the recommendation engine to determine an “objective” (column 412) of “reward.” The type and/or amount of the reward may be defined by a particular issuer bank, and could take different forms (such as loyalty points or the like).

It should be understood that the “Value” column 408 includes entries that correspond to a value (which may be, for example, a U.S. dollar amount or an amount in Euros, and the like) which assigned by the issuer FI to any particular cardholder. Accordingly, entries in the “Value” column 408 may represent an estimate or function of the value at risk to the issuer FI for inadequately handling (or mishandling or mismanaging) that cardholder account. For example, the “Value” of the customer or cardholder represented in row 416 having a payment card account number ending in “6011” is $1000, and thus that cardholder is considered to be a high value customer. Therefore, the issuer FI or issuer bank should make it a priority to contact that cardholder to maintain a good relationship, and perhaps attempt to cross-sell (as suggested in column 412 of row 416) to that cardholder. For example, since this cardholder had a large purchase transaction at a mobile phone retailer, the issuer bank may inform a partner mobile accessories company of the purchase by this cardholder or consumer so that the mobile accessories company can mail the cardholder a discount offer (or otherwise contact the cardholder with an offer). In another example, the issuer bank could have a bank customer service representative contact the cardholder and/or provide a discount coupon to the cardholder related to the products offered by a partner mobile telephone accessories retailer. In yet another example, if the high value cardholder identified in row 416 did not have any E-commerce transactions during a particular time period, such behavior may trigger an objective (recommendation) to the issuer FI to contact that high value cardholder with a message reinforcing the benefits and/or security features of the payment card account for such online transactions. In contrast, the cardholder represented in row 424 having a payment card account ending in “6015” may be transacting and be a regular spender (as shown in columns 404 and 406 of row 424), but still be considered a medium to low value customer, as the “Value” assigned in column 408 of row 424 is only three-hundred and fifty dollars ($350). This cardholder is behaving as expected, and thus has not taken any actions (purchases) to cause a trigger event so, as indicated in column 412 of row 424, an objective of “do not contact” appears in table 400.

Referring again to FIG. 4, a third cardholder with entries in row 418 has a segment entry of “attrition”, a sub-segment entry of “most active”, a value of “four hundred dollars” ($400) and a trigger of “spend reduced fifty to seventy percent” within a predetermined period of time. Since this cardholder is in the “most active” sub-segment, the issuer FI has an interest in retaining the customer as a cardholder and thus the recommendation engine has included an objective of “retain”. In such cases, which may depend on the individual issuer FI, the issuer bank may have a customer care representative place a “courtesy call” to the cardholder, or may instead choose to actively engage the cardholder bearing in mind that the value attributed to the cardholder might justify some investment in order to retain the account.

Referring to row 420 of FIG. 4, a fourth cardholder has a segment entry of “transacting”, a sub-segment of “regular spender”, a value of “six hundred and eighty” ($680) and a trigger of “moved to upgrade tier 1”, and the recommendation engine has included an objective of “upgrade”. Thus, in this case the issuer FI may wish to contact the fourth cardholder and offer an upgrade to a premium credit card account that includes further benefits because there is an opportunity to obtain increased revenues from the spending activity of the third cardholder. In another example, this cardholder may make a first transaction of a particular type (for example, a cross-border purchase transaction) that causes the recommendation engine to propose an objective (recommendation) that incentivizes further usage of the payment card account in that manner to encourage and/or entrench such behavior and possible gain top-of-wallet status (wherein the cardholder increases use of the payment card account to such an extent that it is apparent that it is his or her top payment account of choice).

A fifth cardholder having an account with the last four digits of “6014” with entries in row 422, has a segment entry of “inactive”, a sub-segment of “last spend three months ago”, a value of “five hundred and fifty dollars” ($550), and a trigger of “Entered Inactive segment”. In this case, the recommendation engine has included an objective of “Win Back”. Accordingly, the issuer bank may choose to have a customer care representative call the cardholder in an attempt to find out why that cardholder has stopped using his or her payment card account. If the cardholder, for example, reveals that he or she obtained a new credit card from a rival issuer bank that includes a “teaser” period of enhanced rewards for use, then the issuer bank may either choose to make the cardholder a counter-offer (such as providing a comparable rewards package), or choose to wait until the teaser period of the rival credit card account has expires to see if the cardholder resumes using his or her payment card. In the future, if the cardholder continues to be inactive, then that cardholder may be offered an incentive to resume utilizing that account, or the issuer bank may decide to terminate the payment card account if all efforts to have the cardholder resume using the payment card have failed.

A sixth cardholder with a payment card account number ending in “6015” has entries in row 424 including a segment entry of “transacting”, a sub-segment of “regular spender”, a value of “three hundred and fifty dollars” ($350) and a trigger of “none”. As explained earlier, the recommendation engine determined that the sixth cardholder has been behaving as expected, and thus the objective includes an entry of “do not contact”.

It should be understood that each objective recommended in the “Objective” column may be determined by the recommendation engine based on rules and/or instructions provided by a particular issuer FI or issuer bank, and the rules or instructions may dictated the way in which the data of on one or more of the trigger events, segment, sub-segment, and/or value is used to obtain a recommendation for any particular customer or cardholder. For example, the “Value” of a particular cardholder may carry more weight than a “Segment” or “Sub-segment” entry in some cases, while in other cases the “Trigger” event may carry more weight, with regards to determining an objective or recommendation for a particular cardholder.

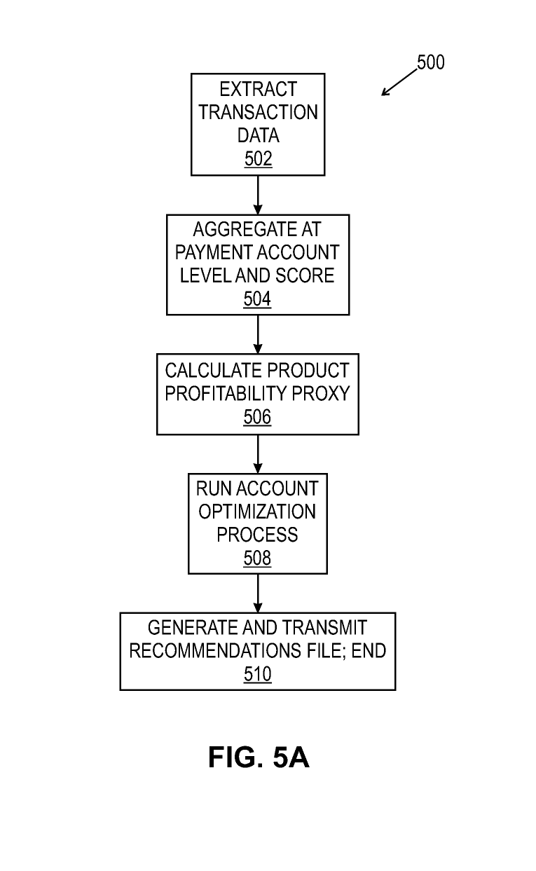

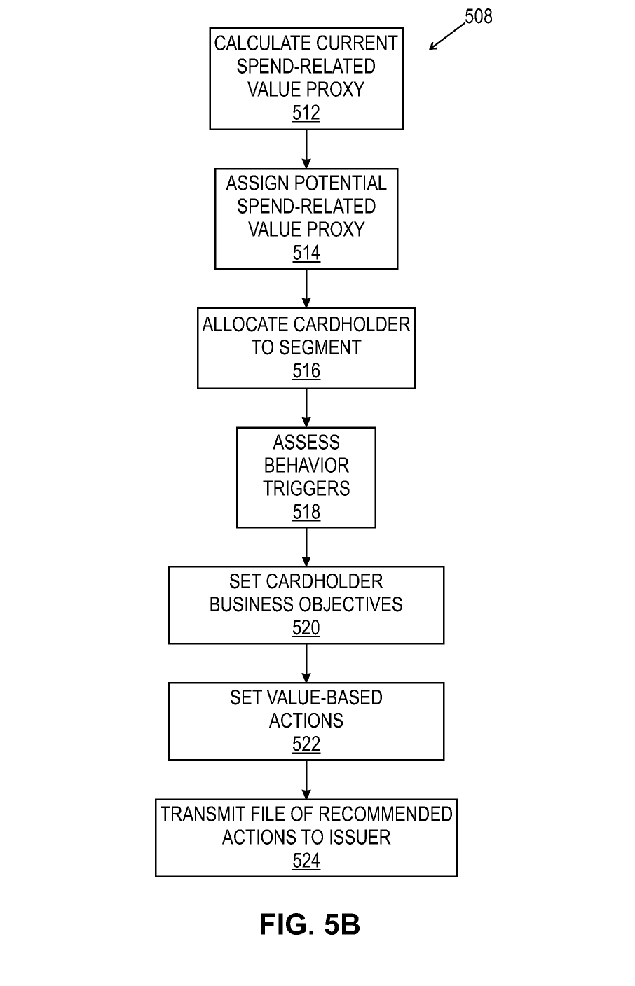

FIG. 5A is a flowchart illustrating a data management and account optimization process 500 in accordance with some embodiments. It should be understood that the flow charts described herein do not imply a fixed order to the steps, and embodiments of the disclosure may be practiced in any order that is practicable. Note that any of the methods described herein may be performed by hardware, software, or any combination of these approaches. For example, a computer-readable storage medium may store thereon instructions that when executed by a processor and/or a machine result in performance according to any of the disclosed embodiments.

Referring to FIG. 5A, the recommendation engine extracts 502 transaction data from the transaction database 106 (FIG. 1), which was obtained during purchase transaction processing of payment cards for a plurality of cardholders. The recommendation engine then aggregates 504 payment card account data at the payment card account level, and calculates all scores currently available (including any custom scores if available for a specific issuer FI). Next, a product profitability proxy is calculated for each cardholder account, for example, by calculating the average interchange rates for a combination of product code, issuer FI country, and merchant country. The staged transaction data is then utilized by the recommendation engine to execute or run 508 an account optimization process 508, and then to generate and transmit 510 a recommendation(s) output file to an issuer FI. The recommendation(s) output file may contain recommended strategic action(s) to take concerning one or more cardholder accounts of that issuer FI, as described above with regard to FIG. 4. Such a process solves the technological problem of how to provide an issuer FI with strategic action recommendations for their cardholders in a timely manner using only the purchase transaction data of those cardholders, so that the issuer FI can take action if the issuer FI so desires. It should be understood that, in some cases the recommended action(s) for the cardholders of a portfolio may not take into consideration one or more operational constraints associated with a particular issuer FI's operations (for example, a limitation on the number of mailings that can occur regarding payment card accounts in a portfolio at a particular point in time). In such cases, that particular issuer FI may determine to ignore one or more recommended strategic actions concerning one or more of their cardholders.

FIG. 5B is a flowchart illustrating an embodiment of the account optimization process 508 of FIG. 5A according to some embodiments. In particular, the recommendation engine calculates 512 for each customer's payment card account a current spend-related value proxy, and then assigns 514 a potential spend-related value proxy for that customer or cardholder. With regard to the current spend-related proxy calculation, the recommendation engine may utilize current spend-related revenue values over a predetermined time period. For example, the current spend-related value proxy may be a value that is based on payment card account usage over the past twelve (12) months across automatic teller machines (ATMs) and/or at point-of-sale (POS) terminals, domestically and cross-border, and that includes a determination of the value of interchange revenue generated for the issuer FI by that cardholder. The potential value proxy may be based on the nature of recent and past spending behavior(s) observed for the payment card account which can lead to assigning a payment card account to a potential value category (such as “Low”, “Medium”, and/or “High”), which may be based on rules that are based on a discretionary-category spend index and/or a premium-category spend index, the current spend (a total amount and/or cross-border amount) and any premium “lookalike” score (if available). In some implementations, the potential value proxy is an estimate of how much value the payment card account could generate for the issuer FI if the issuer bank could further develop or shape cardholder behavior by, for example, enticing the cardholder to increase use of his or her payment card account such that it reaches “front-of-wallet” status. Thus, the current spend-related value proxy and the potential value proxy are key indicators for an issuer bank to make in order to effectively manage its payment card portfolio, as these measures are used to protect revenue at risk, to understand where room for revenue growth may exist, and used to look after (and/or encourage) valuable cardholders.

Referring again to FIG. 5B, the process includes the recommendation engine allocating 516 the customer or cardholder to a predetermined actionable segment. In some embodiments, the recommendation engine tags specific payment card accounts with specific priorities by using segmentation rules to prioritize strategic actions based on existing models and segments. Actionable segments are segments against which specific high-level business strategies can be identified (for example, spend growth, retention, category expansion, upgrades, and the like). The recommendation engine next assesses 518 the existence of any behavior triggers, which are associated with recent events which may justify some kind of communication with the customer (for example, one or more transactions entries may indicate that the cardholder is about to travel abroad, such as purchase of airline tickets). In some implementations, the recommendation engine tags a particular payment card account with each event associated with a behavior trigger, and then uses segmentation rules to prioritize the behavior triggers. The process then continues with the recommendation engine setting 520 a cardholder business objective or recommendation, which may entail the use of rule-based segmentation to refine actionable segments based on the behavioral triggers to determine the most appropriate objective for each payment card account and/or cardholder. Accordingly, the payment card account optimization process steps 516, 518 and 520 include assigning segments, determining how relevant the segments are at the current time for a particular issuer FI, attaching recommendations (a business objective for each of the cardholders associated with that issuer FI) that may recur across segments, and then looking at the trigger behavior(s) to prioritize them in such a way to determine if there was a significant event that justifies contacting a particular cardholder. The initial recommendations are then restated to reflect the recent trigger behavior(s) and the initial value assessment. Thus, in some embodiments, the final recommendation for a particular payment card account (or cardholder) is equal to the value plus the initial segments plus the trigger behavior(s).

Accordingly, in some embodiments the recommendation engine processes transaction data to apply segmentations and scores to each cardholder in an issuer bank's portfolio, to infer a particular cardholder's business or premium status, assign behavioral segments, and finally to consolidate the results into actionable segments from a payment card account portfolio manager's perspective. In some implementations five key business segments are used to assign high-level tags to each cardholder so that, for example, a credit card portfolio manager at an issuer bank FI can be informed of potential issues quickly. The five key business segments correspond to stable primary, primary at risk, secondary, low active, and defected. For example, if a card usage segment of “new primary” or “high active” describes a particular cardholder account, and that account has a high attrition rate score then a tag of “primary at risk” may be assigned to that customer or cardholder. This would be highlighted so that a portfolio manager at the issuer FI or issuer bank is notified, and then he or she then needs to decide if any action is required, for example, to contact the cardholder in a particular manner to insure that the customer does not defect and/or go inactive.

It should be understood that many different types of behavior triggers may warrant a recommendation for any particular issuer FI to contact a cardholder. For example, for new cardholder accounts, behavior triggers of interest may include, but are not limited to, a first transaction, transactions that occur on different days, a transaction occurring one month and/or three months since the first transaction, a first e-commerce transaction, a first cross-border transaction, and/or a first cash withdrawal transaction. For established payment card accounts, examples of trigger events that could prompt a recommendation that the issuer bank contact the customer or cardholder may include no payment card transactions for 7 days and/or 15 days and/or one month and/or 3 months and/or 6 months. An issuer bank may also wish to contact an established cardholder if a large spend amount was recorded with a mobile phone retailer, or with an electronics or home appliances merchant, or with a furniture merchant, or associated with a holiday sale. Other types of trigger events may include certain transactions that occur every month, or certain transactions not occurring every month, some all cash transactions, some all point-of-sale (POS) transactions, when a POS to cash ratio is above or below certain levels, cross-border spending (card present), e-commerce transactions, and/or dynamic currency exchange transactions. In addition, trigger events such as purchases in particular areas such as travel-related items (for example, airline tickets, hotel reservations, rental car reservations, and the like), mobile phone-related areas, and/or purchases at specific retailers may prompt a recommendation for the issuer bank to contact the cardholder. In addition, certain trigger events may be included for some issuer FIs that wish to provide rewards and/or encourage certain behaviours, for example, for staying within a regular spenders and/or most active segment for a predetermined time period, such as one year, two years, and the like, and/or for moving up to the regular spenders and/or most active segments, and/or for making certain types of purchases, such as purchases at supermarkets, at gas stations, at restaurants, and/or for mobile device-related items.

Cardholder business objectives may be based on the actionable segments and triggers, and in some embodiments are used to determine the most appropriate objective for a payment card account and/or customer or cardholder. In some implementations, the purpose of setting business objectives is to modify the previously set business objective for each payment card account so that it also reflects any behavioral triggers that may have occurred. Thus, any trigger events taking place in the current period offers an opportunity to communicate with one or more cardholders in a relevant and timely fashion. In some embodiments, the original business objectives are tagged for immediate attention to signify that the communication taking place in relation to a trigger event should be conceived as part of a concerted effort aimed at improving the issuer bank's engagement with the cardholder. In some implementations, there are seven key business objectives, which include “upgrade to commercial”, “upgrade to premium”, “retain”, “nurture”, “secondary to primary”, “re-engage”, and “re-acquire”. For example, if a payment card account has a “secondary to primary” business objective and starts transacting in a new industry, the issuer bank can leverage a communication opportunity presented by this event to encourage more widespread usage of the payment card account. In this case, the key business objective would be amended to “Immediate secondary to primary” to indicate a higher priority for action. Thus, the actionable segments set the overall direction of the issuer bank's efforts for a predetermined set of payment card accounts of a portfolio, while triggers are utilized for inferring more tactical and/or opportunistic interventions which can be particularly important when determining the timing of marketing communications. As mentioned above, recommending any particular business objective depends on the cardholder's business segment and triggers, but may also depend on the current or potential value, card product type, and whether a high business score or a low business score was assigned.

Referring again to FIG. 5B, the recommendation engine next sets value-based actions 522. The value-based actions are assigned to each payment card account based on the current cardholder account value or the potential cardholder account value and the assigned business objective, wherein specific recommendations are aligned with the issuer bank's ability to customize treatments across segments and deploy them in a timely manner. Finally, as also shown in FIG. 5A (step 510), the recommendation engine generates and transmits 524 a recommendation data file to the issuer FI computer, wherein the recommendation data file contains one or more recommended actions for each cardholder in the issuer bank's payment card portfolio.

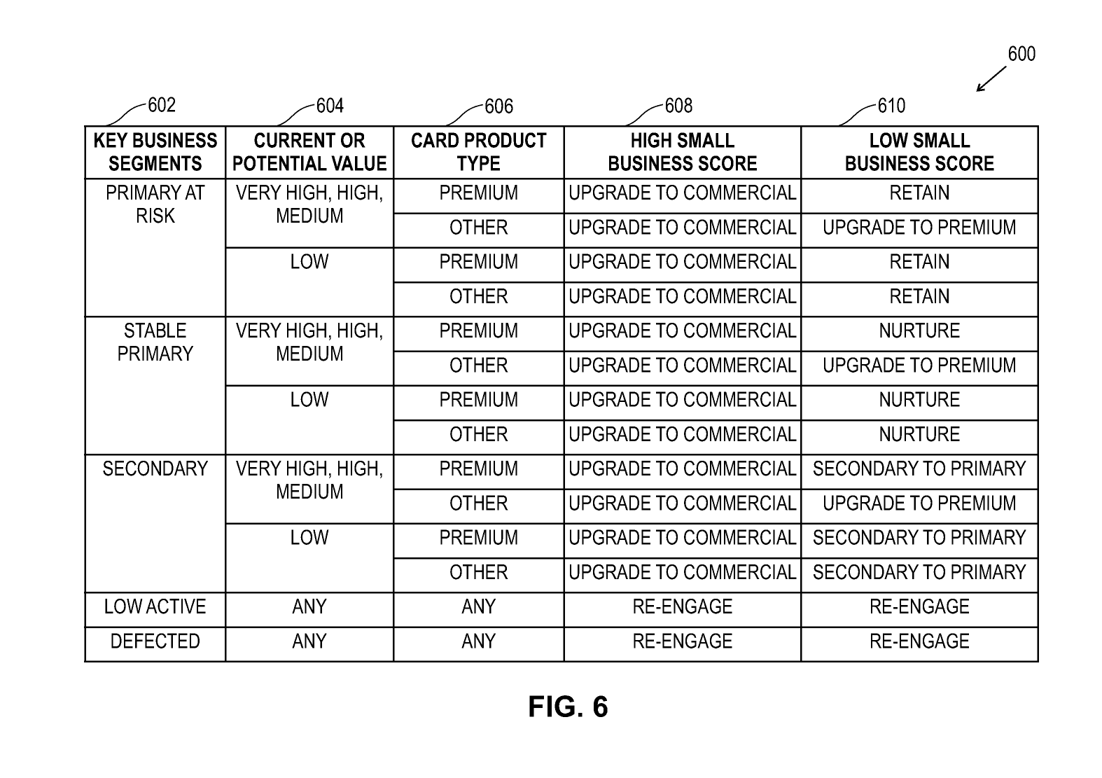

FIG. 6 is a table 600 that provides a guide for determining a key business objective for any particular cardholder based on various factors. In particular, a recommendation for pursuing a particular business objective depends upon which key business segment 602 that the cardholder belongs to, the current or potential value 604 of that cardholder, the card product type 606, and whether or not a particular cardholder received a high small business score 608 or low small business score 610. For example, when a cardholder is in the “primary at risk” business segment, if the current or potential value is “very high, high or medium” and the cardholder has an “other” type of card product and a low small business score, then the objective is to upgrade that cardholder to a premium card. If that same cardholder instead has a high small business score, then the business objective is to upgrade the cardholder to a commercial payment card account. Moreover, with regard to the table 600, the objective for all cardholders with high small business scores in the “primary at risk”, “stable primary” and “secondary” segments is to upgrade those payment card accounts to commercial payment card accounts. When these same cardholders have low small business scores, then various types of business objectives, which include “upgrade to premium”, “retain”, “nurture”, “secondary to primary”, “re-engage”, and “re-acquire” can be recommended, depending on their current or potential value and the card product type (Premium or Other) as depicted. In some embodiments, any specific recommendation for a cardholder is aligned with the issuer bank's ability to customize treatments across segments and/or commensurate with their ability to deploy a customer contact in a timely manner.

Accordingly, the systems, apparatus and processes disclosed herein operate to provide insights to issuer banks regarding actions to take concerning the cardholders in their payment card account portfolios. Recommended contact actions and/or business objectives for the cardholders of a particular issuer bank can be generated by a recommendation engine based on the transaction data generated and/or stored by a payment network. The recommendation data may be in the form of a data file, which may be in a table format, and may be transmitted to the issuer bank on a predetermined basis.

As used herein and in the appended claims, the term “computer” should be understood to encompass a single computer or two or more computers in communication with each other or a computer network or computer system.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

The flow charts and descriptions thereof herein should not be understood to prescribe a fixed order of performing the method steps described therein. Rather, the method steps may be performed in any order that is practicable. In addition, the flow charts described herein should not be understood to require that all steps or elements be practiced in every embodiment. For example, one or more elements or steps may be omitted in some embodiments.

As used herein and in the appended claims, the term “payment card account” includes a credit card account or a deposit account or other type of financial account that an account holder may access. The term “payment card account number” includes a number that identifies a payment card system account or a number carried by a payment card, or a number that is used to route a transaction in a payment system that handles debit card and/or credit card transactions. The term “payment card” may include, but is not limited to a credit card, a debit card, a transit card, an identification card, a loyalty card, and/or a gift card.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A recommendation service method, comprising:
extracting, by a recommendation engine from a payment card transaction database, payment account transaction data of a plurality of payment card accounts;
aggregating, by the recommendation engine, the payment account transaction data of the plurality of payment card accounts associated with an issuer financial institution (FI) at a payment card account level;
calculating, by the recommendation engine, a payment card account product profitability proxy amount for each of the aggregated payment card accounts;
executing, by the recommendation engine, an adaptive optimization process;
generating, by the recommendation engine, a recommendations file comprising one recommended action associated with each of the payment card accounts of the issuer FI; and
transmitting, by the recommendation engine to an issuer FI computer, the recommendations file.

2. The method of claim 1, wherein executing the adaptive optimization process comprises:
calculating, by the recommendation engine, a current spend-related value proxy for each payment card account of the issuer FI;
assigning, by the recommendation engine, a potential spend-related value proxy to each payment card account of the issuer FI;
allocating, by the recommendation engine, each payment card account to an actionable segment;
assessing, by the recommendation engine, relevance of payment account activity for each payment card account based on at least one of a plurality of trigger events; and
setting, by the recommendation engine, a business objective for each payment card account based on the assessment.

3. The method of claim 2, wherein the recommendation engine calculates the current spend-related value proxy based on current spend-related revenue values over a predetermined period of time for each payment card account.

4. The method of claim 2, wherein the recommendation engine assigns the potential spend-related value proxy based on rules associated with at least one of a discretionary-category spend index and a premium category spend index.

5. The method of claim 2, wherein the recommendation engine allocates an actionable segment based on segmentation rules that prioritize strategic actions.

6. The method of claim 2, wherein assessing the relevance of payment account activity comprises:
tagging, by the recommendation engine, a payment card account with each event associated with a behavior trigger; and
applying, by the recommendation engine, segmentation rules to prioritize the behavior triggers.

7. The method of claim 2, wherein setting the business objective further comprises utilizing rule-based segmentation to determine a most appropriate objective for each payment card account.

8. The method of claim 1, wherein transmitting the data file further comprises transmitting, by the recommendation engine, the data file to the issuer FI computer on a periodic basis.

9. The method of claim 8, wherein the periodic bases comprises at least one of daily, weekly, monthly, quarterly, bi-yearly, yearly, and upon issuer FI request.

10. The method of claim 1, wherein the payment account transaction data is limited to transaction data that occurred within a predetermined time frame.

11. The method of claim 10, wherein the predetermined time frame comprises one of a one-day period, one-week period, one-month period, a three-month period, a six-month period and a twelve-month period.

12. The method of claim 1, wherein the payment account is associated with at least one of a credit card account, a debit card account, a loyalty card account, and a pre-paid card account.

13. The method of claim 1, wherein the transaction information comprises at least one of a primary account number (PAN), a merchant identifier, a date, a time of day, a payment amount, and a payment description.

14. A non-transitory, computer-readable medium storing instructions configured to cause a recommendation engine to:
extract payment account transaction data of a plurality of payment card accounts from a payment card transaction database;
aggregate the payment account transaction data of the plurality of payment card accounts associated with an issuer financial institution (FI) at a payment card account level;
calculate a payment card account product profitability proxy amount for each of the aggregated payment card accounts;
execute an adaptive optimization process;
generate a recommendations file comprising one recommended action associated with each of the payment card accounts of the issuer FI; and
transmit the recommendations file to an issuer FI computer.

15. The non-transitory, computer-readable medium of claim 14, wherein the instructions for executing an adaptive optimization process further comprise instructions configured to cause the recommendation engine to:
calculate a current spend-related value proxy for each payment card account of the issuer FI;
assign a potential spend-related value proxy to each payment card account of the issuer FI;
allocate each payment card account to an actionable segment;
assess relevance of payment account activity for each payment card account based on at least one of a plurality of trigger events; and
set a business objective for each payment card account based on the assessment.

16. The non-transitory, computer-readable medium of claim 15, wherein the instructions for calculating the current spend-related value proxy further comprise instructions configured to cause the recommendation engine to calculate the current spend-related value proxy based on current spend-related revenue values over a predetermined period of time for each payment card account.

17. The non-transitory, computer-readable medium of claim 15, wherein the instructions for assigning a potential spend-related value proxy to each payment card account further comprise instructions configured to cause the recommendation engine to assign the potential spend-related value proxy based on rules associated with at least one of a discretionary-category spend index and a premium category spend index.

18. The non-transitory, computer-readable medium of claim 15, wherein the instructions for allocating an actionable segment further comprise instructions configured to cause the recommendation engine to allocate an actionable segment based on segmentation rules that prioritize strategic actions.

19. The non-transitory, computer-readable medium of claim 15, wherein the instructions for assessing the relevance of payment account activity further comprise instructions configured to cause the recommendation engine to:
tag a payment card account with each event associated with a behavior trigger; and
apply segmentation rules to prioritize the behavior triggers.

20. The non-transitory, computer-readable medium of claim 15, wherein the instructions for setting the business objective further comprise instructions configured to cause the recommendation engine to utilize rule-based segmentation to determine a most appropriate objective for each payment card account.

21. A purchase transaction and strategic action recommendation system, comprising:
a payment network comprising a payment processor operably connected to a transaction database, wherein the transaction database stores purchase transaction information associated with a plurality of payment card accounts;
a plurality of issuer financial institution (FI) computers operably connected to the payment network;
a plurality of acquirer FI computers operably connected to the payment network; and
a recommendation engine operably connected to the transaction database, to a recommendation database, and to the plurality of issuer FI computers, the recommendation database storing instructions configured to cause the recommendation engine to:
extract payment account transaction data of a plurality of payment card accounts from the payment card transaction database;
aggregate the payment account transaction data of the plurality of payment card accounts associated with a particular issuer FI at a payment card account level;
calculate a payment card account product profitability proxy amount for each of the aggregated payment card accounts of the particular issuer FI;
execute an adaptive optimization process;
generate a recommendations file comprising one recommended action associated with each of the payment card accounts of the issuer FI; and
transmit the recommendations file to an issuer FI computer of the issuer FI.
